(19) United States
(12) Patent Application Publication
(10) Pub. No.: US 2024/0411677 A1
(43) Pub. Date: Dec. 12, 2024

(54) SYSTEMS AND METHODS FOR REPROVISIONING A STORAGE DEVICE

(71) Applicant: Samsung Electronics Co., Ltd., Suwon-si (KR)

(72) Inventors: Matthew Bryson, Los Gatos, CA (US); Naga Sanjana Bikonda, San Jose, CA (US); Wenjie Liu, San Jose, CA (US); Vishwanath Maram, San Jose, CA (US)

(21) Appl. No.: 18/238,351

(22) Filed: Aug. 25, 2023

Related U.S. Application Data
(60) Provisional application No. 63/471,922, filed on Jun. 8, 2023.

(51) Int. Cl. G06F 12/02

(52) U.S. Cl. CPC G06F 12/02

(57) ABSTRACT

Systems and methods for reprovisioning a storage device are disclosed. The storage device comprises a storage medium having a first storage capacity and a second storage capacity; and a processor coupled to the storage medium. The processor may be configured to identify a trigger condition. Based on identifying the trigger condition, the processor may be configured to: identify the first storage capacity and the second storage capacity; identify a first amount; modify the first storage capacity based on the first amount; and modify the second storage capacity based on the first amount.

### CROSS-REFERENCE TO RELATED APPLICATION(S)

The present application claims priority to and the benefit of U.S. Provisional Application No. 63/471,922, filed Jun. 8, 2023, entitled “REUTILIZATION OF LIVE SECTORS FROM SSDS PAST FAILURE THRESHOLD,” the entire content of which is incorporated herein by reference.

### FIELD

One or more aspects of embodiments according to the present disclosure relate to storage devices, and more particularly to reprovisioning a storage device upon detecting a trigger condition.

### BACKGROUND

An application may interact with a storage or memory device (collectively referenced as storage device) for reading (or loading) and writing (or storing) data. After a certain amount of reads and writes to the storage device, however, one or more memory cells may fail. It may be desirable to maximize use of the storage device before the storage device is discarded.

The above information disclosed in this Background section is only for enhancement of understanding of the background of the present disclosure, and therefore, it may contain information that does not form prior art.

### SUMMARY

One or more embodiments of the present disclosure are directed to a storage device comprising a storage medium having a first storage capacity and a second storage capacity; and a processor coupled to the storage medium. The processor is configured to identify a trigger condition. Based on identifying the trigger condition, the processor is configured to: identify the first storage capacity and the second storage capacity; identify a first amount; modify the first storage capacity based on the first amount; and modify the second storage capacity based on the first amount.

According to some embodiments, the first storage capacity is available to a computing device for storing data.

According to some embodiments, the second storage capacity is for a background memory operation.

According to some embodiments, the trigger condition includes a determination that the second storage capacity satisfies a criterion.

According to some embodiments, the processor is further configured to: identify a first memory block forming part of the first storage capacity; and modify an attribute of the first memory block to associate the first memory block with the second storage capacity.

According to some embodiments, the processor is further configured to: identify an attribute of a first memory block; and based on the processor identifying the attribute, store data in the first memory block into a second memory block forming part of the second storage capacity.

According to some embodiments, the processor being configured to identify the attribute of the first memory block includes the processor being configured to identify the attribute of the first memory block based on a first identifier, wherein the processor being configured to associate the first memory block with the second storage capacity includes associating the first memory block with a second identifier.

According to some embodiments, the processor is further configured to: operate the storage device in a first operation mode; and format the storage device based on the processor being configured to modify the first storage capacity.

According to some embodiments, the processor is further configured to:

transmit a notification to a computing device based on the processor being configured to modify the first storage capacity.

According to some embodiments, the first amount is based on a target associated with the second storage capacity.

One or more embodiments of the present disclosure are further directed to a method comprising: identifying, by a processor, a trigger condition; based on identifying the trigger condition: identifying, by the processor, a first storage capacity and a second storage capacity of a storage medium; identifying, by the processor, a first amount; modifying, by the processor, the first storage capacity based on the first amount; and modifying, by the processor, the second storage capacity based on the first amount.

These and other features, aspects and advantages of the embodiments of the present disclosure will be more fully understood when considered with respect to the following detailed description, appended claims, and accompanying drawings. Of course, the actual scope of the invention is defined by the appended claims.

### BRIEF DESCRIPTION OF THE DRAWINGS

Non-limiting and non-exhaustive embodiments of the present embodiments are described with reference to the following figures, wherein like reference numerals refer to like parts throughout the various views unless otherwise specified.

FIG. 1 depicts a simplified example of a storage system according to one or more embodiments;

FIG. 2 depicts a block diagram of a storage controller according to one or more embodiments;

FIG. 3 depicts a conceptual layout diagram of a non-volatile memory according to one or more embodiments;

FIG. 4 depicts a conceptual layout diagram of example memory blocks stored in a non-volatile memory of a storage device according to one or more embodiments;

FIG. 5 depicts a conceptual layout diagram of the memory blocks in FIG. 4, after resizing of the storage device according to one or more embodiments;

FIG. 6 depicts a conceptual layout diagram of a mapping table according to one or more embodiments;

FIG. 7 depicts a flow diagram of a process for resizing a storage device according one or more embodiments; and

FIG. 8 depicts another flow diagram of a process for resizing a storage device according to one or more embodiments.

### DETAILED DESCRIPTION

Hereinafter, example embodiments will be described in detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, descriptions thereof may not be repeated. Further, in the drawings, the relative sizes of elements, layers, and regions may be exaggerated and/or simplified for clarity.

Embodiments of the present disclosure are described below with reference to block diagrams and flow diagrams. Thus, it should be understood that each block of the block diagrams and flow diagrams may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (for example the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flow diagrams. Accordingly, the block diagrams and flow diagrams support various combinations of embodiments for performing the specified instructions, operations, or steps.

A storage device such as, for example, a solid state drive (SSD) or other NAND-based storage device may be discarded upon reaching a failure threshold. One reason why an SSD may fail is because the NAND flash can generally only withstand a limited number of program/erase (P/E) cycles. For example, when data is written into the NAND flash, the data already stored in a memory cell is erased first before the new data is written. This is because NAND is erased at the block level granularity, but written at the page granularity. The P/E cycles may cause wear of the device, causing it to ultimately fail. Thus, a failure threshold may be set based on a maximum P/E cycle count that NAND flash can generally tolerate. An SSD that has reached the maximum P/E cycle count may be deemed to be a failed device, and may typically be discarded.

SSDs may use wear-leveling to distribute wear evenly across cells. Due to wear-leveling, whole blocks of data typically fail around the same time. However, this may not be uniformly true. There may still be a degree of non-determinism to the failure of memory cells. Because SSDs may not fail deterministically, some memory cells may continue to work even if the SSD has reached an established failure threshold (e.g., a maximum number of P/E cycles), and other memory cells may fail before reaching the established failure threshold.

In some storage device implementations, there may be an expectation that some number of NAND cells may fail prior to reaching the failure threshold. Thus, the storage device may include an overprovisoned space that may be used for remapping failed sectors of the storage device. As the number of failed sectors or blocks increase, the size of the overprovisioned space (e.g., availability of the overprovisioned space) decreases. The overprovisioned space may eventually decrease to a level at which there may not be sufficient space for sector reallocations and other background memory operations. When availability of the overprovisioned space drops to a minimum level, the SSD may be deemed to have reached a failure threshold, and may typically be discarded. In general terms, one or more embodiments of the present disclosure are

directed to systems and methods for reprovisioning (or reformatting) a storage device to extend life (e.g., use) of the storage device that has satisfied, or is approaching, an end-of-life condition. By extending the life of the storage device, the storage device may continue functioning as normally, allowing data to be read and written from the storage device. In some embodiments, an end-of-life condition is satisfied when a certain number of usable memory blocks have failed, without sufficient blocks to reestablish the overprovisioned region of the device.

In some embodiments, a controller of the storage device is configured to monitor for a trigger condition. The trigger condition may be, for example, a minimum threshold amount of overprovisioned space remaining on the storage device, detecting failure of a threshold number of memory blocks, and/or the like. In response to detecting the trigger condition, the storage controller may identify the usable memory blocks of the storage device. The usable memory blocks may be the blocks that may be available (e.g., advertised) to a host computing device for storing data. The storage controller may replenish the overprovisioned space from the usable memory blocks.

Allocating usable blocks to the overprovisioned space may lead to shrinkage of the usable space. Nonetheless, by extending the life of the storage device (although with a reduced storage size), the storage device may be more environmentally friendly and help reduce the climate impact of the storage device. Recycling the storage device may also help decrease the total cost of ownership (TCO) of the storage device.

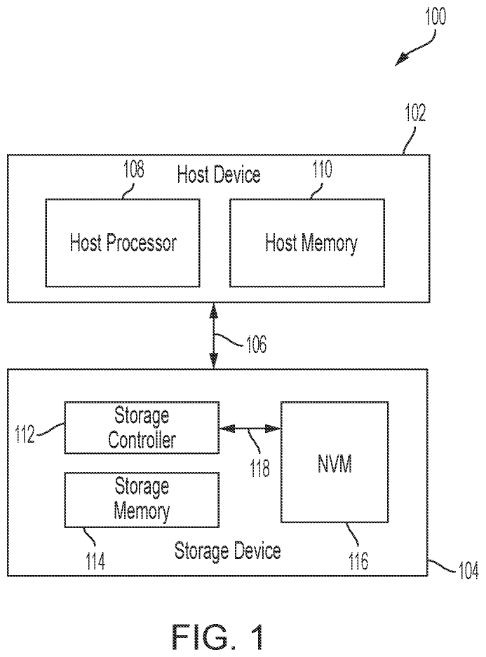

FIG. 1 depicts a simplified example of a storage system 100 in which one host computing device 102 is connected to one storage device 104, but the present disclosure is not limited thereto, and the storage system 100 may include any suitable number of host devices that are each connected to any suitable number of storage devices. Further, the storage system 100 may include a plurality of storage devices that may be connected to the same host device (e.g., the host device 102) or different host devices.

Referring to FIG. 1, the host device 102 may be connected to the storage device 104 over a host interface 106. The host device 102 may issue data requests or commands (e.g., write/store, read/load, erase, commands) to the storage device 104 over the host interface 106, and may receive responses from the storage device 104 over the host interface 106. For example, the responses may include requested data stored in the storage device 104, and/or a notification from the storage device 104 that a corresponding data request command has been successfully executed by the storage device 104.

In some embodiments, a data request, such as, for example, a load or store request, may be generated during the running of an application by the host device 102.

For example, the application 112 may be a big data analysis application, e-commerce application, database application, machine learning application, and/or the like. Results of the data request may be used by the application to generate an output.

The host device 102 may include a host processor 108 and host memory 110. The host processor 108 may be a processing circuit, for example, such as a general purpose processor or a central processing unit (CPU) core of the host device 102. The host processor 108 may be connected to other components via an address bus, a control bus, a data bus, and/or the like. The host memory 110 may be considered as high performing main memory (e.g., primary memory) of the host device 102. For example, in some embodiments, the host memory 110 may include (or may be) volatile memory, for example, such as dynamic random-access memory (DRAM). However, the present disclosure is not limited thereto, and the host memory 210 may include (or may be) any suitable high performing main memory (e.g., primary memory) replacement for the host device 102 as would be known to those skilled in the art. For example, in other embodiments, the host memory 110 may be relatively high performing non-volatile memory, such as NAND flash memory, Phase Change Memory (PCM), Resistive RAM, Spin-transfer Torque RAM (STTRAM), any suitable memory based on PCM technology, memristor technology, and/or resistive random access memory (ReRAM), and can include, for example, chalcogenides, and/or the like.

The storage device 104 may be considered as secondary memory that may persistently store data accessible by the host device 102. For example, in some embodiments, the storage device 104 may be secondary memory of the host device 102, for example, such as a Solid-State Drive (SSD). However, the present disclosure is not limited thereto, and in other embodiments, the storage device 104 may include (or may be) any suitable storage device, for example, such as a magnetic storage device (e.g., a hard disk drive (HDD), and the like), an optical storage device (e.g., a Blue-ray disc drive, a compact disc (CD) drive, a digital versatile disc (DVD) drive, and the like), other kinds of flash memory devices (e.g., a USB flash drive, and the like), and/or the like. In various embodiments, the storage device 104 may conform to a large form factor standard (e.g., a 3.5 inch hard drive form-factor), a small form factor standard (e.g., a 2.5 inch hard drive form-factor), an M.2 form factor, an E1.S form factor, and/or the like. In other embodiments, the storage device 104 may conform to any suitable or desired derivative of these form factors. For convenience, the storage device 104 may be described hereinafter in the context of an SSD, but the present disclosure is not limited thereto.

The storage device 104 may be communicably connected to the host device 102 over the host interface 106. The host interface 106 may facilitate communications (e.g., using a connector and a protocol) between the host device 102 and the storage device 104. In some embodiments, the host interface 106 may facilitate the exchange of storage requests and responses between the host device 102 and the storage device 104. In some embodiments, the host interface 106 may facilitate data transfers by the storage device 104 to and from the host memory 110 of the host device 102. For example, in various embodiments, the host interface 106 (e.g., the connector and the protocol thereof) may include (or may conform to) Compute Express Link (CXL), Cache Coherent

Interconnect for Accelerators (CCIX), dual in-line memory module (DIMM) interface, Small Computer System Interface (SCSI), Non Volatile Memory Express (NVMe), Peripheral Component Interconnect Express (PCle), remote direct memory access (RDMA) over Ethernet, Serial Advanced Technology Attachment (SATA), Fiber Channel, Serial Attached SCSI (SAS), NVMe over Fabric (NVMe-oF), iWARP protocol, InfiniBand protocol, 5G wireless protocol, Wi-Fi protocol, Bluetooth protocol, and/or the like. In some embodiments, the host interface 106 (e.g., the connector and the protocol thereof) may include (or may conform to) various general-purpose interfaces, for example, such as Ethernet, Universal Serial Bus (USB), and/or the like.

In some embodiments, the storage device 104 may include a storage controller 112, storage memory 114, non-volatile memory (NVM) 116, and a storage interface 118. The storage memory 114 may be high-performing memory of the storage device 104, and may include (or may be) volatile memory, for example, such as DRAM, but the present disclosure is not limited thereto, and the storage memory 114 may be any suitable kind of high-performing volatile or non-volatile memory.

The NVM 116 may persistently store data received, for example, from the host device 102. The NVM 116 may include, for example, NAND flash memory, but the present disclosure is not limited thereto, and the NVM 116 may include any suitable kind of memory for persistently storing the data according to an implementation of the storage device 104 (e.g., phase-change memory (PCM), conductive-bridging random access memory (CBRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like).

The storage controller 112 may be connected to the NVM 116 over the storage interface 118. The storage interface 118 may be an interface with which the NVM 116 (e.g., NAND flash memory) may communicate with a processing component (e.g., the storage controller 112) or other device. Commands such as reset, write enable, control signals, clock signals, and/or the like may be transmitted over the storage interface 118. Further, a software interface may be used in combination with a hardware element that may be used to test/verify the workings of the storage interface 118. The software may be used to read and write data to the NVM 116 via the storage interface 118. Further, the software may include firmware that may be downloaded onto the hardware elements (e.g., for controlling write, erase, and read operations).

The storage controller 112 may be connected to the host interface 106, and may manage signaling over the host interface 106. In some embodiments, the storage controller 112 may include an associated software layer to manage the physical connector of the host interface 106. The storage controller 112 may respond to IO requests received from the host device 102 over the host interface 106. The storage controller 112 may also manage the storage interface 118 to control, and to provide access to and from, the NVM 116. For example, the storage controller 112 may include at least one processing component embedded thereon for interfacing with the host device 102 and the NVM 116. The processing component may include, for example, a digital circuit (e.g., a microcontroller, a microprocessor, a digital signal processor, or a logic device (e.g., a field programmable gate array (FPGA), an application-specific integrated circuit (ASIC), and/or the like)) capable of executing data access instructions (e.g., via firmware and/or software) to provide access to and from the data stored in the NVM 116 according to the data access instructions. For example, the data access instructions may correspond to the data request commands, and may include any suitable data storage and retrieval algorithm (e.g., read/load, write/store, erase, etc.) instructions, and/or the like.

According to one or more embodiments of the present disclosure, the storage controller 112 may monitor one or more physical blocks, chunks, pages, or sectors (collectively referenced as a memory block) of the NVM 116, for determining allocation, status, or attribute (also collectively referenced as status) of the memory block. For example, the storage controller 112 may monitor the one or more memory blocks for determining whether the blocks have failed (also referred to as “dead”), whether they contain data, whether the contained data is valid or invalid, and/or the like. The storage controller may further monitor the one or more memory blocks to determine the mapping of the memory blocks to a usable space of the storage device, an overprovisioned space, or failed (dead) space. For example, one or more logical blocks referenced by the host may be mapped to a physical memory blocks associated with the usable space, overprovisioned space, or failed space.

In some embodiments, the usable space of the storage device 104 may include the space that is declared or made available to the host device 102 for loading and storing data. In some embodiments, the dead space of the storage device may include physical memory blocks that have failed. In some embodiments, the overprovisioned space may include the space of the storage device that is used for bad sector reallocations and other background memory operations. In some embodiments, the overprovisioned space may not be visible to the host device 102.

As an example, a storage device with 1 Terabyte (TB) of usable space may be advertised to the host device 102 as a 1 TB storage device. The storage device may include an overprovisioned space that may be 10% of the usable space (e.g., 100 Gigabytes). Thus, although the storage device according to this example is advertised as a 1 TB storage device, the physical capacity of the storage device may be 1.1 TB. In some embodiments, the storage controller 112 is configured to take action to extend the life of a storage device 104 when the device approaches an end-of-life condition. In some embodiments, the end-of-life condition is met when the available space of the storage device 104 no longer has sufficient capacity to replenish the overprovision space. The storage device 104 may be deemed to be a failed device upon satisfying the end-of-life condition, even though there may be memory blocks in the usable space that have not failed.

In some embodiments, reprovisioning of the storage device 104 includes remapping one or more usable physical memory blocks that are associated with the usable space of the storage device, to be associated with the overprovisioned space. The remapping of the usable blocks may cause reduction of the storage capacity of the usable space. The number of usable blocks that are selected for remapping may depend on the amount needed to replenish the overprovisioned space. In some embodiments, the overprovisioned space is replenished to be a percentage (e.g., 10%) of the new usable space.

In some embodiments, reprovisioning of the storage device 104 includes remapping one or more usable memory blocks that are associated with the usable space of the storage device, to be associated with the overprovisioned space. The remapping of the usable blocks may cause reduction of the storage capacity of the usable space. The number of usable blocks that are selected for remapping may depend on the amount needed to replenish the overprovisioned space. In some embodiments, the overprovisioned space is replenished to be a percentage (e.g., 10%) of the new usable space.

In some embodiments, the reprovisioning of the storage device 104 includes reformatting the device. The storage device 104 may be reformatted based on the reduced usable space and the replenished overprovisioned space. The reformatted storage device 104 may then be presented to the host device 102 as a new device.

In some embodiments, a notification is transmitted to the host device prior to reformatting of the storage device 104. The notification may prompt the host device to move data stored in the device, into another storage medium (e.g., another storage device). In this regard, the storage controller 112 transitions the storage device 104 into a read-only recovery mode, to allow data stored in the NVM 116 to be read (or recovered) by the host device 102. No new data may be allowed to be written into the NVM 116 during the real-only recovery mode.

In some embodiments, instead of prompting the host device 102 to move all the data stored in the device, the storage controller 112 may calculate an amount of space needed from the usable space to replenish the overprovisioned space. The storage controller 112 may prompt the host device 102 to delete a target amount of data associated with the needed space.

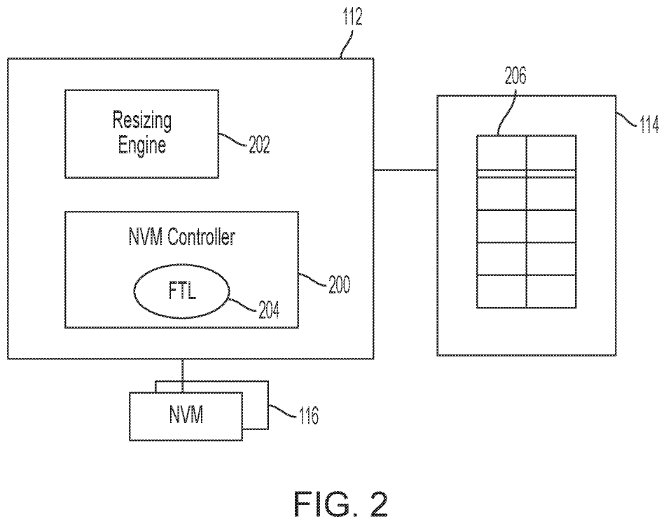

FIG. 2 depicts a block diagram of the storage controller 112 according to one or more embodiments. The storage controller 112 includes an NVM controller 200 and a resizing engine 202, which may be implemented via hardware, firmware, software, or a combination of hardware, firmware, and/or software. Although the NVM controller 200 and resizing engine 202 are assumed to be separate components, a person of skill in the art will recognize that one or more of the components may be combined or integrated into a single component, or further subdivided into further sub-components without departing from the spirit and scope of the inventive concept.

In some embodiments, the NVM controller 200 and resizing engine 202 may include, for example, a digital circuit (e.g., a microcontroller, a microprocessor, a digital signal processor, or a logic device (e.g., a field programmable gate array (FPGA), an application-specific integrated circuit (ASIC), and/or the like (collectively referenced as a processor)). The digital circuit may access a memory (e.g., the memory 114) that stores instructions (e.g., software, firmware, and/or hardware code) for being executed by the processor to implement the functionalities of the storage controller 112.

In some embodiments, the NVM controller 200 is configured to receive data access requests from the host device 102. In some embodiments, the NVM controller 200 includes a flash translation layer (FTL) 204 that receives the data access request and interfaces with the NVM 120 to read data from, and write data to, the NVM. In this regard, the FTL 204 may translate a memory block address (e.g., a logical block address (LBA)) included in the data access request, to a flash (physical) block address. In doing so, the FTL 204 may engage in wear leveling to move data around the storage cells of the NVM 120 to evenly distribute the writes to the NVM 120.

In some embodiments, the FTL 204 maintains a mapping table 206 for translating an LBA to a physical address of the NVM 116. In some embodiments, the mapping table further includes status of the one or more memory blocks (e.g., usable, provisioned, available, etc.). The mapping table 206 may be stored, for example, in the memory 114 of the storage device 104.

In some embodiments, the resizing engine 202 is configured to receive information from the NVM controller 200 (e.g., from the FTL 208) for determining whether the storage device 104 should be resized. For example, the resizing engine 202 may receive information on the live memory blocks of the NVM 116 (e.g., the total number of memory blocks excluding the dead blocks, and/or a total storage capacity provided by the live memory blocks). The resizing engine 202 may determine availability of the overprovisioned space compared to the total or usable storage capacity. If the available overprovisioned space is less than a minimum threshold value (e.g., 1%) of the total or usable storage space, the resizing engine 202 may trigger resizing of the storage device 104.

In some embodiments, resizing of the storage device 104 includes computing an amount of overprovisioned space for the resized storage device. The amount of overprovisioned space may be a percentage of the capacity provided by the remaining usable memory blocks. The newly computed overprovisioned space may be smaller than the overprovisioned space originally allocated to the storage device 104.

In some embodiments, the resizing engine 202 calculates a number of memory blocks from the usable storage portion of the NVM 116 that should be reassigned to the overprovisioned space. The resizing engine 202 may communicate with the NVM controller 200 to reassign the determined number of memory blocks to the overprovisioned space. The NVM controller 200 may select the memory blocks to be reassigned, and update the mapping table 206 accordingly.

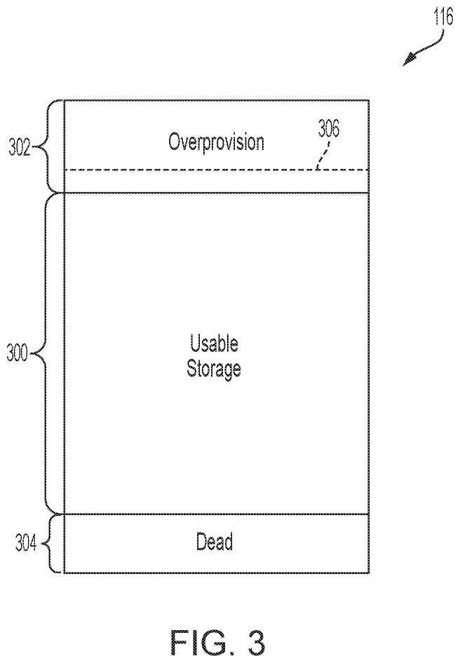

FIG. 3 depicts a conceptual layout diagram of the NVM 116 according to one or more embodiments. The NVM 116 includes one or memory blocks making up a usable storage space 300. The usable storage space 300 may have a first storage capacity that may be advertised to the host device 102.

The NVM 116 also includes one or more memory blocks making up an overprovisioned space 302. The overprovisioned space 302 may have a second storage capacity. The second storage capacity may be a percentage (e.g., 10-20%) of the advertised usable storage. The overprovisioned space 302 may be used for bad sector reallocations and other background memory operations. In some embodiments, the overprovisioned space may not be visible to the host device 102.

As P/E operations on the NVM 118 cause wear of the memory cells, one or more memory blocks may fail. The NVM controller 200 may detect a failure characteristic to determine that a memory sector has failed. Example failure characteristics include, for example, repeated check sum failures, read/write disturbance errors, and/or sector reallocations. In regards to sector reallocations, a sector that is reallocated using the overprovisioned space 302 may be considered failed, and identified as such.

The failed memory blocks may contribute to a dead or failed portion 304 of the NVM 118. A failed memory sector may be reallocated to the overprovisioned space 302 in a sector reallocation process. As the number of bad sectors increase with continued use of the storage device 104, the availability of the overprovisioned space 302 may decrease. In some embodiments, if the available overprovisioned space falls below a minimum threshold level 306, the resizing engine 202 may trigger resizing of the storage device 104.

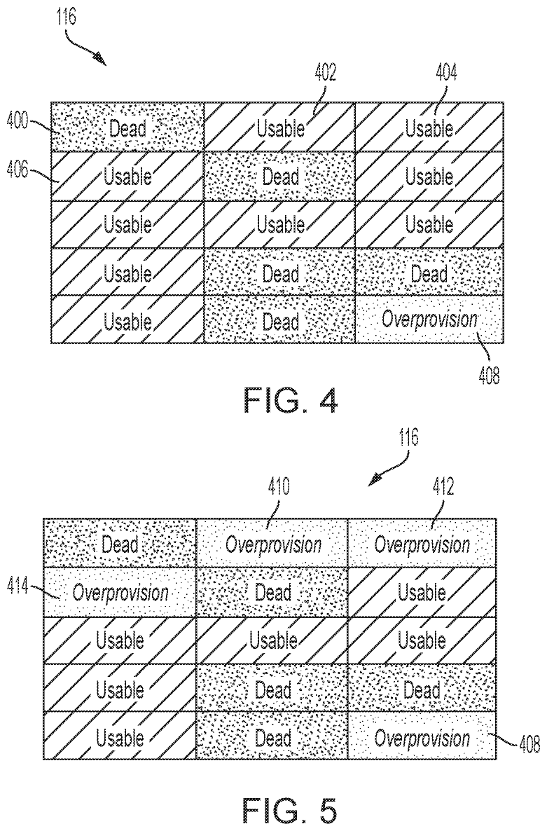

FIG. 4 depicts a conceptual layout diagram of example memory blocks stored in the NVM 116 according to one or more embodiments. The example memory blocks may include one or more dead memory blocks 400, one or more usable memory blocks 402-406, and one or more overprovision blocks 408. The status of the memory blocks may be maintained by the NVM controller 200 (e.g., in the mapping table 206). The dead memory blocks 400 may be blocks that have satisfied a failure characteristic and are deemed to have failed. For example, a block with repeated check sum failures, read/write disturbance errors, and/or subject to a sector reallocation may be deemed to have failed.

The usable memory blocks 402-406 may be blocks that are available to the host device 102 for storing data. The usable memory blocks 402-406 may be empty or contain data accessible to the host device 102. The usable blocks 402 may together provide a first storage capacity for the storage device 104.

The overprovision blocks 404 may be memory blocks in the storage device 104 that have been identified for use as overprovisioned space. The overprovision blocks 404 may together form a second storage capacity of the storage device 104 that may be used for background memory operations and bad sector reallocations.

FIG. 5 depicts a conceptual layout diagram of the memory blocks in FIG. 4, after resizing of the storage device 104, according to one or more embodiments. In the example of FIG. 5, the usable blocks 402-406 are removed or disassociated from the usable storage space, and added or associated to the overprovisioned space as overprovision blocks 410-412.

In some embodiments, the resizing engine 202 selects the usable blocks 402-406 based on identifying an amount for storage space needed to replenish the overprovision space. The calculation of the overprovisioned space that is needed may be based on the number of usable blocks remaining in the storage device. More and more blocks may fail with continued use of the storage device. The resizing may occur until the number of live blocks (e.g., the total number of usable blocks and overprovision blocks) fall below a minimum threshold.

In some embodiments, the mapping table 206 is updated based on reassignment of a usable memory block 402-406 as an overprovision block 410-414. In addition, the first storage capacity may be reduced, and the second storage capacity may be increased, based on the reallocation of the usable memory blocks 402-406 to the overprovisioned space.

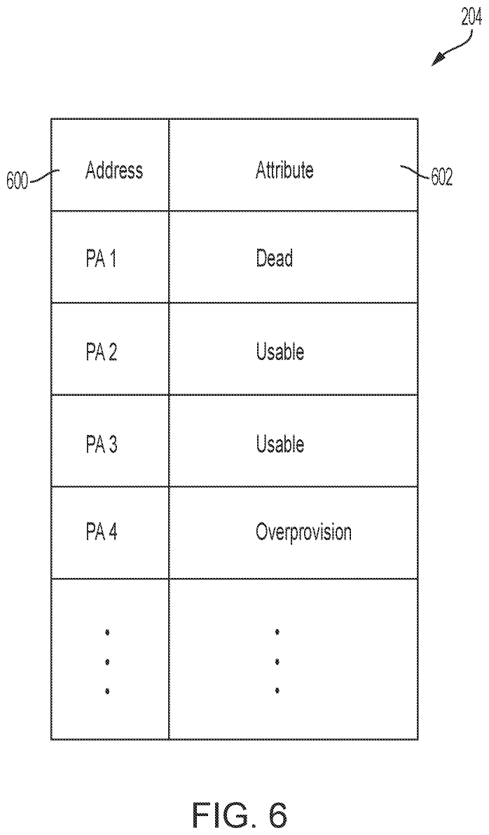

FIG. 6 depicts a conceptual layout diagram of a mapping table 206 according to one or more embodiments. The mapping table 206 may include an address 600 of a memory block, and a status identifier 602 corresponding to the address. The address may be, for example, a physical flash address of the NVM 116. In some embodiment, the mapping table 206 is an extension of the FTL 204.

The status identifier 602 corresponding to the address 600 may identify the memory block as being dead, usable, or overprovision, although embodiments are not limited thereto. In some embodiments, the mapping table 206 may further include the logical memory address (e.g., LBA) associated with the physical address 600, and/or other attributes about the memory block such as, empty, allocated, and/or the like.

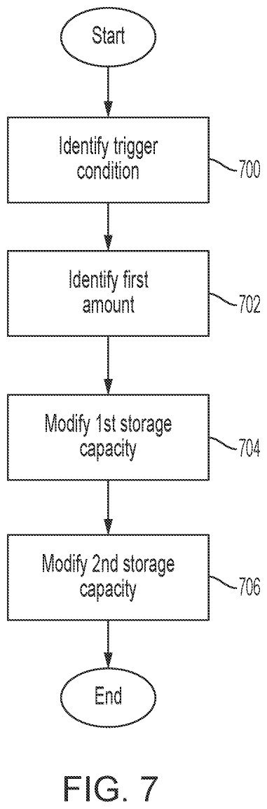

FIG. 7 depicts a flow diagram of a process for resizing the storage device 104 according one or more embodiments. The process starts, and in act 700, the storage controller 112 (e.g., the resizing engine 202) identifies a trigger condition. In some embodiments, the trigger condition is detected in response to the storage device 104 being within a certain range of an end-of-life condition. For example, the end-of-life condition may be exhaustion of the overprovisioned storage space. The trigger condition may be detected in response to the available overprovisioned space falling below a threshold value (e.g., 1% of available overprovisioned space left). In some embodiments, the trigger condition may be detected in response to the live memory blocks in the storage device 104 falling below a threshold value. The live memory blocks may include both usable blocks and available overprovision blocks.

In act 702, the storage controller 112 (e.g., the resizing engine 202), identifies a first amount. The first amount may be based on a target goal for the overprovisioned space (e.g., a second storage capacity). The target goal for the overprovisioned space may be a percentage of the usable storage capacity (e.g., a first storage capacity) remaining in the storage device 104. For example, the target amount may be 10%-20% of the usable storage capacity. In some embodiments, the target amount may be larger than a customary amount (e.g., larger than 20%) in anticipation that more memory blocks will fail as the storage device 102 continues to be used past its intended life. The larger target amount may avoid a need to frequently engage in the resizing process. In some embodiments, the first amount may include a number of memory blocks to be reassigned from the usable space to the overprovisioned space, to achieve the target goal.

In act 704, the resizing engine 202 modifies (e.g., shrinks) the usable storage capacity based on the identified first amount. For example, the usable storage space may shrink below the storage capacity advertised to the host device 102. In this regard, one or more memory blocks mapped to the usable storage space are identified based on the first amount, and reassigned to the overprovisioned space.

In act 706, the resizing engine 202 modifies (e.g., increases) the overprovisioned space based on the identified first amount. For example, one or more memory blocks mapped to the usable storage space may be reassigned to the overprovisioned space. The mapping table 206 may be updated accordingly based on the reassignment. For example, the status identifier 602 of the address corresponding to the one or more memory blocks may be updated to indicate that the memory blocks are now overprovision blocks.

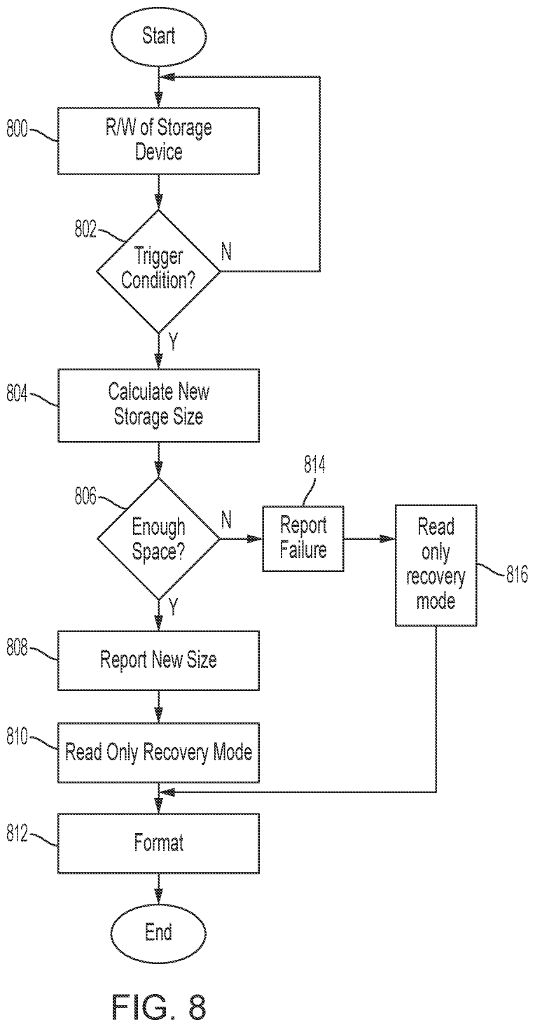

FIG. 8 depicts another flow diagram of a process for resizing the storage device 104 according to one or more embodiments. The process starts, and in act 800, the host device 102 transmits read/load and write/store commands to the storage device 104 as one or more applications are executed by the host device 102.

In act 802, the storage controller 112 (e.g., the resizing engine 202) determines whether a trigger condition has been satisfied. In some embodiments, the trigger condition is satisfied if the storage device 104 is within a certain range of an end-of-life condition. For example, the end-of-life condition may be exhaustion of the overprovisioned storage space. The trigger condition may be detected in response to the available overprovisioned space falling below a threshold value (e.g., 1% of available overprovisioned space left). In some embodiments, the trigger condition is satisfied in response to the live memory blocks in the storage device 104 falling below a threshold value. The live memory blocks may include both usable blocks and available overprovision blocks.

In act 804, the storage controller 200 (e.g., the resizing engine 202), calculates a new storage size for the storage device 104. For example, the resizing engine 202 may calculate the amount of available overprovisioned space left in the NVM 116, and compare it against a desired amount. The desired amount may be a percentage of the usable memory blocks left in the NVM 116. The resizing engine 202 may calculate a number of usable blocks that will be needed to be remapped as overprovision blocks in order to replenish the overprovisioned space to the desired amount. The remapping of the usable memory blocks may reduce the usable space available to the host device 102.

In act 806, a determination is made as to whether there are sufficient usable blocks to replenish the overprovisioned space, while maintaining a desired amount of usable memory space.

If the answer is YES, the storage controller 200 notifies, in act 808, the host device 102 of the new (decreased) capacity of the storage device 104. The new capacity advertised to the host device 102 may be the current capacity minus the capacity to be reallocated to the overprovisioned space. In some embodiments, the notification for the new capacity is accompanied with instructions to remove data from the storage device 104.

In act 810, the storage device 104 is placed in a read-only recovery mode. During this mode, the storage controller 112 is allowed to execute a read operation from the host device 102, but a request for a write operation causes the storage controller 112 to return an error message. During the read-only, the host may issue read operations for removing data stored in the storage device 104, prior to reformatting the storage device.

In act 812, the host issues a command for format the storage device 104 based on the new usable storage space and new overprovisioned space. The formatting may include erasing data stored in the storage device, deallocating the LBAs, and/or the like. After formatting, the storage device 104 may be ready to be used by the host device 102 to store data, but at a lower capacity than the prior version of the storage device.

In some embodiments, instead of placing the storage device 104 in a read-only recovery mode to allow the host device 102 to remove the data stored in the device, the storage device may compute an amount of data that should be deleted to effectuate the reprovisioning. The storage device 104 may prompt the host device 102 to delete the calculated amount of data. In response to the prompt, the host device 102 may identify the data that is to be deleted. The storage controller 112 may delete the identified data from the storage device. The deletion of the data in the usable space may allow the storage device to replenish the overprovisioned space with memory blocks from the usable space.

A storage device that may be reprovisioned to extend the life of the device as described according to the various embodiments of the present disclosure may be desirable in one or more computing environments. For example, it may be desirable in a hyperscaler or data center environment where storage is already abstracted and includes several levels of redundancy. Resizing a storage device in the abstracted storage pool may be automatic, and without interruption in service, and help improve the total cost of ownership of the reprovisioned storage device.

The reprovisioning of a storage device may also be desirable in a redundant array of independent disks (RAID) system with a parity controller that may detect that one of the storage devices has failed (e.g., is approaching an end-of-life condition). The data in the failed device may be moved to another storage device in the array, and the failed device may be resized automatically and re-inserted into the array, without interruption of use of the RAID system.

The reprovisioning of a storage device may also be desirable to an ordinary consumer to decrease the total cost of ownership of the storage device. The consumer may simply offload the data in the failed storage device, and continue use of the device after it has been resized.

A person of skill in the art should recognize that the reprovisioning of a storage device to extend the life of the device provides advantages including improvement in the climate impact, improvement in the device's total cost of ownership, and/or the like.

One or more embodiments of the present disclosure may be implemented in one or more processors. The term processor may refer to one or more processors and/or one or more processing cores. The one or more processors may be hosted in a single device or distributed over multiple devices (e.g. over a cloud system). A processor may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processor, as used herein, each function is performed either by hardware configured, i.e., hard-wired, to perform that function, or by more general-purpose hardware, such as a CPU, configured to execute instructions stored in a non-transitory storage medium (e.g. memory). A processor may be fabricated on a single printed circuit board (PCB) or distributed over several interconnected PCBs. A processor may contain other processing circuits; for example, a processing circuit may include two processing circuits, an FPGA and a CPU, interconnected on a PCB.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed herein could be termed a second element, component, region, layer or section, without departing from the spirit and scope of the inventive concept.

The terminology used herein is for the purpose of describing particular embodiments only and is not intended to be limiting of the inventive concept. Also, unless explicitly stated, the embodiments described herein are not mutually exclusive. Aspects of the embodiments described herein may be combined in some implementations.

As used herein, the terms “substantially,” “about,” and similar terms are used as terms of approximation and not as terms of degree, and are intended to account for the inherent deviations in measured or calculated values that would be recognized by those of ordinary skill in the art.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

Although exemplary embodiments of systems and methods for reprovisioning a storage device have been specifically described and illustrated herein, many modifications and variations will be apparent to those skilled in the art. Accordingly, it is to be understood that systems and methods for reprovisioning a storage device constructed according to principles of this disclosure may be embodied other than as specifically described herein. The disclosure is also defined in the following claims, and equivalents thereof.

The systems and methods for reprovisioning a storage device may contain one or more combination of features set forth in the below statements.

Statement 1. A storage device comprising: a storage medium having a first storage capacity and a second storage capacity; and a processor coupled to the storage medium, the processor being configured to: identify a trigger condition; based on identifying the trigger condition: identify the first storage capacity and the second storage capacity; identify a first amount; modify the first storage capacity based on the first amount; and modify the second storage capacity based on the first amount.

Statement 2. The storage device of Statement 1, wherein the first storage capacity is available to a computing device for storing data.

Statement 3. The storage device of Statement 1, wherein the second storage capacity is for a background memory operation.

Statement 4. The storage device of Statement 1, wherein the trigger condition includes a determination that the second storage capacity satisfies a criterion.

Statement 5. The storage device of Statement 4, wherein the processor is further configured to: identify a first memory block forming part of the first storage capacity; and modify an attribute of the first memory block to associate the first memory block with the second storage capacity.

Statement 6. The storage device of Statement 1, wherein the processor is further configured to: identify an attribute of a first memory block; and based on the processor identifying the attribute, store data in the first memory block into a second memory block forming part of the second storage capacity.

Statement 7. The storage device of Statement 6, wherein the processor being configured to identify the attribute of the first memory block includes the processor being configured to identify the attribute of the first memory block based on a first identifier, wherein the processor being configured to associate the first memory block with the second storage capacity includes associating the first memory block with a second identifier.

Statement 8. The storage device of Statement 7, wherein the processor is further configured to: operate the storage device in a first operation mode; and format the storage device based on the processor being configured to modify the first storage capacity.

Statement 9. The storage device of Statement 1, wherein the processor is further configured to: transmit a notification to a computing device based on the processor being configured to modify the first storage capacity.

Statement 10. The storage device of Statement 1, wherein the first amount is based on a target associated with the second storage capacity.

Statement 11. A method comprising: identifying, by a processor, a trigger condition; based on identifying the trigger condition: identifying, by the processor, a first storage capacity and a second storage capacity of a storage medium; identifying, by the processor, a first amount; modifying, by the processor, the first storage capacity based on the first amount; and modifying, by the processor, the second storage capacity based on the first amount.

Statement 12. The method of Statement 11, wherein the first storage capacity is available to a computing device for storing data.

Statement 13. The method of Statement 11, wherein the second storage capacity is for a background memory operation.

Statement 14. The method of Statement 11, wherein the trigger condition includes a determination that the second storage capacity satisfies a criterion.

Statement 15. The method of Statement 14 further comprising: identifying a first memory block forming part of the first storage capacity; and modifying an attribute of the first memory block to associate the first memory block with the second storage capacity.

Statement 16. The method of Statement 11 further comprising: identifying an attribute of a first memory block; and based on the processor identifying the attribute, storing data in the first memory block into a second memory block forming part of the second storage capacity.

Statement 17. The method of Statement 16, wherein the identifying the attribute of the first memory block includes identifying the attribute of the first memory block based on a first identifier, wherein the associating the first memory block with the second storage capacity includes associating the first memory block with a second identifier.

Statement 18. The method of Statement 17 further comprising: operating the storage device in a first operation mode; and formatting the storage device based on the modifying the first storage capacity.

Statement 19. The method of Statement 11 further comprising: transmitting a notification to a computing device based on modifying the first storage capacity.

Statement 20. The method of Statement 11, wherein the first amount is based on a target associated with the second storage capacity.

What is claimed is:

1. A storage device comprising:
a storage medium having a first storage capacity and a second storage capacity; and
a processor coupled to the storage medium, the processor being configured to:
identify a trigger condition;
based on identifying the trigger condition:
identify the first storage capacity and the second storage capacity;
identify a first amount;
modify the first storage capacity based on the first amount; and
modify the second storage capacity based on the first amount.

2. The storage device of claim 1, wherein the first storage capacity is available to a computing device for storing data.

3. The storage device of claim 1, wherein the second storage capacity is for a background memory operation.

4. The storage device of claim 1, wherein the trigger condition includes a determination that the second storage capacity satisfies a criterion.

5. The storage device of claim 4, wherein the processor is further configured to:
identify a first memory block forming part of the first storage capacity; and
modify an attribute of the first memory block to associate the first memory block with the second storage capacity.

6. The storage device of claim 1, wherein the processor is further configured to:
identify an attribute of a first memory block; and
based on the processor identifying the attribute, store data in the first memory block into a second memory block forming part of the second storage capacity.

7. The storage device of claim 6, wherein the processor being configured to identify the attribute of the first memory block includes the processor being configured to identify the attribute of the first memory block based on a first identifier, wherein the processor being configured to associate the first memory block with the second storage capacity includes associating the first memory block with a second identifier.

8. The storage device of claim 7, wherein the processor is further configured to:
operate the storage device in a first operation mode; and
format the storage device based on the processor being configured to modify the first storage capacity.

9. The storage device of claim 1, wherein the processor is further configured to:
transmit a notification to a computing device based on the processor being configured to modify the first storage capacity.

10. The storage device of claim 1, wherein the first amount is based on a target associated with the second storage capacity.

11. A method comprising:
identifying, by a processor, a trigger condition;
based on identifying the trigger condition:
identifying, by the processor, a first storage capacity and a second storage capacity of a storage medium;
identifying, by the processor, a first amount;
modifying, by the processor, the first storage capacity based on the first amount; and
modifying, by the processor, the second storage capacity based on the first amount.

12. The method of claim 11, wherein the first storage capacity is available to a computing device for storing data.

13. The method of claim 11, wherein the second storage capacity is for a background memory operation.

14. The method of claim 11, wherein the trigger condition includes a determination that the second storage capacity satisfies a criterion.

15. The method of claim 14 further comprising:
identifying a first memory block forming part of the first storage capacity; and
modifying an attribute of the first memory block to associate the first memory block with the second storage capacity.

16. The method of claim 11 further comprising:
identifying an attribute of a first memory block; and
based on the processor identifying the attribute, storing data in the first memory block into a second memory block forming part of the second storage capacity.

17. The method of claim 16, wherein the identifying the attribute of the first memory block includes identifying the attribute of the first memory block based on a first identifier, wherein the associating the first memory block with the second storage capacity includes associating the first memory block with a second identifier.

18. The method of claim 17 further comprising:
operating the storage device in a first operation mode; and
formatting the storage device based on the modifying the first storage capacity.

19. The method of claim 11 further comprising:
transmitting a notification to a computing device based on modifying the first storage capacity.

20. The method of claim 11, wherein the first amount is based on a target associated with the second storage capacity.
